(19) United States
(12) Patent Application Publication
(10) Pub. No.: US 2005/0062362 A1
(43) Pub. Date: Mar. 24, 2005

(54) Oscillatory gyroscope

(76) Inventors: Hongyuan Yang, Colorado Springs, CO (US); Marc Alan Straub, Manitou Springs, CO (US); Hugh Daniel Miller, Elbert, CO (US)

Correspondence Address: LAW OFFICE OF DALE B. HALLING, 24 s. WEBER ST., SUITE 311, COLORADO SPRINGS, CO, 80903, US

(21) Appl. No.: 10/889,750

(22) Filed: Jul. 13, 2004

Related U.S. Application Data
(60) Provisional application No. 60/498,544, filed on Aug. 28, 2003.

(51) Int. Cl. H02N 1/00

(52) U.S. Cl. 310/309

(57) ABSTRACT

An oscillatory gyroscope has a pair of oscillatory plates that oscillating in a plane. A pedestal is coupled to the pair of oscillatory plates. A pair of sensing capacitors is not in the plane. A pair of opposing flexures may be coupled to the pedestal and to the pair of oscillatory plates.

### RELATED APPLICATIONS

The present invention claims priority on provisional patent application, Ser. No. 60/498,544, filed on Aug. 28, 2003, entitled “Differential Capacitive Sensing Micro-Machined Oscillatory Gyroscope”.

### FIELD OF THE INVENTION

The present invention relates generally to the field of gyroscopes and more particularly to an oscillatory gyroscope for measuring angular rate.

### BACKGROUND OF THE INVENTION

Micro-machined or Micro-Electrical Mechanic Systems (MEMS) gyroscopes operate in two modes simultaneously, driving mode and sensing mode. Typically these gyroscopes come in two types coupled and decoupled. A coupled gyroscope has the two oscillatory modes share a common mechanical flexure while a decoupled gyroscope has separate mechanical flexure for each mode. A coupled design is less mechanically complicated, but usually has a large quadrature error. The quadrature error results from the driving motion being coupled to the sensing motion. A high quadrature error results in higher noise levels and less resolution. A coupled design requires finding a specific mechanical flexure design which meets the spring constant requirement for both the driving and sensing motion. A decoupled design reduces the quadrature error by utilizing two separated mechanical flexures for the driving and the sensing motion. This simplifies the effort for the mechanical flexure design since only one spring constant target has to met for each mechanical flexure. However, having two sets of springs results in a vulnerability to erroneous vibrations and its undesirable resonance modes. In addition, both types of previous designs are affected by linear acceleration. Linear acceleration can be a major source of noise for these types of gyroscopes. Another concern is packaging stress which can have great impact on both types of designs. In either design, the movable mechanical structures are often suspended to anchor points at multiple locations on the substrate. The substrate experiences stress when packaged, which results in a deformation. This deformation then propagates to the movable mechanical structure via the multiple anchor points, causing either buckling or warping of the structure.

Thus there exists a need for an oscillatory gyroscope that is simple mechanically, i.e., a couple design in nature, has a low quadrature error, is less sensitive to linear acceleration and is less susceptible to packing stress

### SUMMARY OF INVENTION

An oscillatory gyroscope that overcomes these and other problems has a pair of oscillatory plates that oscillating in a plane. A single pedestal is coupled to the pair of oscillatory plates. A pair of sensing capacitors is not in the plane. A pair of opposing flexures may be coupled to the pedestal and to the pair of oscillatory plates. A driving mode of the pair of oscillatory plates is linear and a sensing mode of the pair of oscillatory plates is rotational. A drive natural frequency is approximately equal to a sense natural frequency of the pair of oscillatory plates. A first comb drive actuator may be coupled to one of the pair of oscillatory plates and a second comb drive actuator may be coupled to the other of the pair of oscillatory plates. The first comb drive may include a stationary plate and a movable plate. The second comb drive may also include a stationary plate and a movable plate. A drive voltage may be applied to the both comb drives

In one embodiment, an oscillatory gyroscope has a pedestal with a first end attached to a substrate. A first planar proof mass is attached to a second end of the pedestal. A second planar proof mass is in a same plane as the first planar proof mass and is attached to the second end of the pedestal. A first conductive plate is spaced from the first planar proof mass and is not in the same plane as the first planar proof mass. A second conductive plate is spaced from the second planar proof mass and is not in the same plane as the second planar proof mass. A differential sensor electrically may be coupled to the first conductive plate and the second conductive plate. A first drive actuator acts on the first planar proof mass. A second drive actuator acts on another planar proof mass. The first planar proof mass and the second planar proof mass may oscillate in the same plane in a drive mode. A drive natural frequency is approximately equal to a sense natural frequency of the first planar proof mass and the second planar proof mass.

In one embodiment, an oscillatory gyroscope has a pair of oscillatory proof masses which have a linear drive mode and a rotational sense mode. A pair of electrical sense plates is separated from the pair of oscillatory proof masses. A drive natural frequency is approximately equal to a sense natural frequency of the pair of oscillatory proof masses. A single mechanical structure that supports both the drive mode and the sensing mode holds the pair of oscillatory proof masses to a substrate. A pair of flexures couples the single mechanical structure to the pair of oscillatory proof masses. A pair of drive actuators drives the pair of oscillatory proof masses. A differential sensor may be electrically coupled to the pair of electrical sense plates.

### BRIEF DESCRIPTION OF THE DRAWINGS

FIG. 1 is a partial perspective view of an oscillatory gyroscope in accordance with one embodiment of the invention;

FIG. 2 is a top view of the oscillatory gyroscope in accordance with one embodiment of the invention;

FIG. 3 is a side view of the oscillatory gyroscope in accordance with one embodiment of the invention;

FIG. 4 is a schematic diagram of the sensing electronics in accordance with one embodiment of the invention;

FIG. 5 is a top view of an oscillatory gyroscope in accordance with one embodiment of the invention;

FIG. 6 is a top view of an oscillatory gyroscope with electrical connections in accordance with one embodiment of the invention; and

FIG. 7 is a partial perspective view of an oscillatory gyroscope in accordance with one embodiment of the invention.

### DETAILED DESCRIPTION OF THE DRAWINGS

The oscillatory gyroscope described herein reduces the quadrature error, virtually eliminates the errors due to linear acceleration, and reduces the impact of packaging stress on the mechanical structure. The quadrature error is reduced by having the driving motion decoupled from the sensing motion. The differential sensing mechanism virtually eliminates the errors due to linear acceleration. The impact of packaging stress is reduced because the movable mechanical structure is only connected to one anchor point on the substrate, in one embodiment. Therefore, the deformation of substrate cause by packaging stress does not result in buckling or warping of the movable mechanical structure.

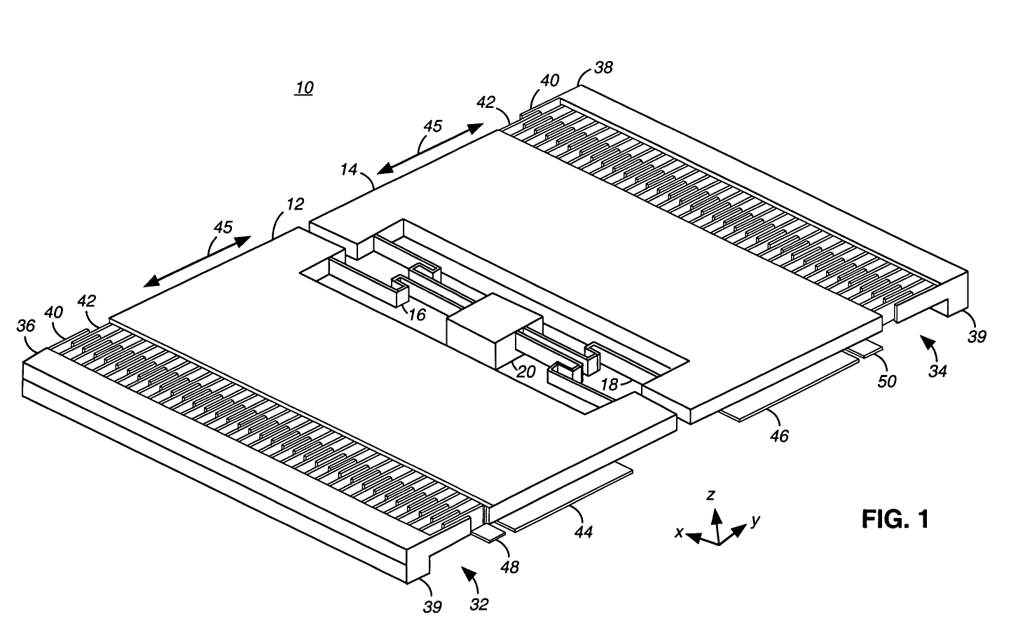

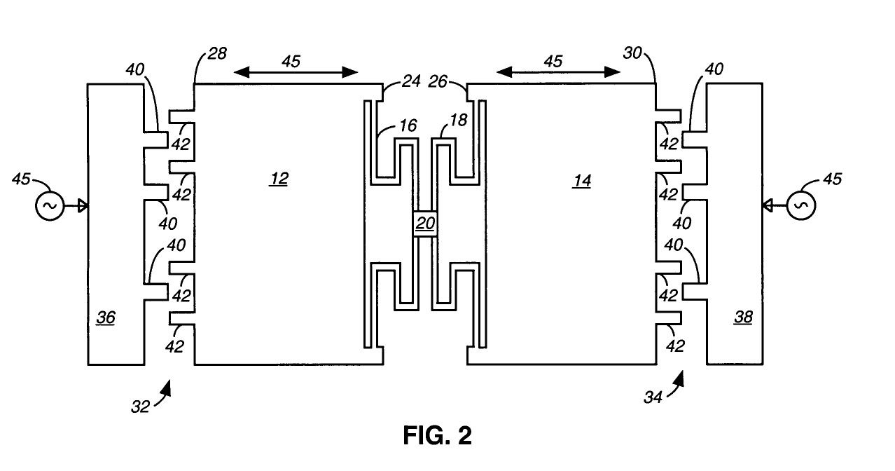

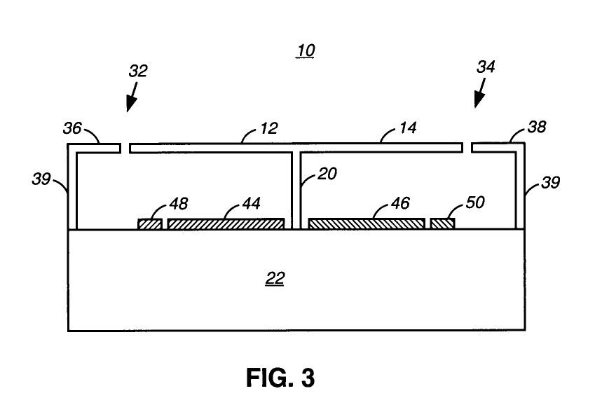

FIG. 1 is a partial perspective view of an oscillatory gyroscope 10 in accordance with one embodiment of the invention. The oscillatory gyroscope 10 has a pair of movable plates or proof masses 12, 14. The movable plates 12, 14 are planar proof masses that are in the same plane. Moveable plate 12 is suspended by flexures 16. Moveable plate 14 is suspended by flexures 18. The flexures 16, 18 are coupled to single pedestal 20 (More easily seen in FIGS. 2 & 3) and have an action similar to a spring. The pedestal 20 is coupled to a substrate 22 (shown in FIG. 2). At first end 24 of the moveable plate 12 is the flexure 16 and at the second end 28 is a first actuator 32. At first end 26 of the moveable plate 14 is the flexure 18 and at the second end 30 is a second actuator 34. In the embodiment shown in FIG. 2 the actuators 32, 34 are comb drive actuators. Comb drive actuators 32, 34 have a stationary plate 36, 38. The stationary plates 36, 38 are attached to the substrate 22 by posts 39 (shown in FIG. 3). The posts 39 are structurally rigid. The station plates 36, 38 have teeth 40. A mating set of teeth 42 can be found on the moveable plates 12, 14. A time varying voltage source 45 is applied to the stationary plates 36, 38 while the moveable plates 12, 14 are tied to a common electrical potential. The voltage source 45 causes a voltage difference between the stator teeth 40 and the moveable teeth 42 which causes the moveable plates 12, 14 to oscillate in the drive direction 45, but with a phase difference of 180°. As can be seen in FIGS. 1 & 2 the moveable plates 12, 14 oscillate in the same plane defined by the plates 12, 14. Note that other actuation schemes may be used to induce the drive motion of the plates 12, 14.

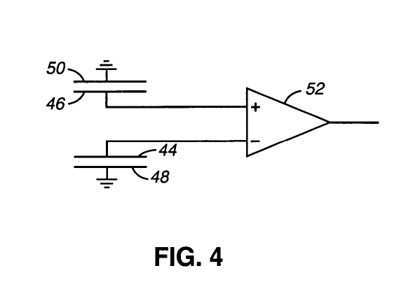

Below the moveable plates 12, 14 are a pair of conductive plates 44, 46 (See FIG. 3). The conductive plates 44, 46 are formed on a substrate 22. These conductive plates 44, 46 are essentially identical. The conductive plates may be metal or a conductive semiconductor such as a doped silicon. The conductive surfaces 44 & 12 form a first sensor capacitor and the plates 46 & 14 form a second sensor capacitor. The capacitance of these capacitors 44, 12 and 46, 14 depends on the relative position between the two plates 44, 12 or 46, 14 and the dielectric property of the media between the plates. The sensor capacitors 44, 12 and 46, 14 are coupled to a differential sensor 52 (See FIG. 4). The output 54 of the sensor 52 is used to determine the angular rate of the gyroscope 10.

Two tuning plates 48, 50 are adjacent to the conductive plates 44, 46. The tuning plates 48, 50 are formed of a conductive material such as metal or a doped semiconductor. By placing an electrical DC bias on these tuning plates the rotational or sensing natural frequency may be adjusted so that it matches the drive natural frequency.

The gyroscope 10 has a linear drive motion 45, as can be seen in FIG. 1. The moveable plates 12, 14 are made to oscillate in an opposing motion about the pedestal 20 with 180° phase difference. The voltage source 45 has a frequency that drives the moveable plates 12, 14 into its natural resonate frequency along the Y-axis also called the drive natural frequency. The drive natural frequency is determined by the mass of the moveable plates and the restoring force of the flexures 16, 18. When the gyroscope is subjected to rotation along any axis in space which is parallel to its “X” axis, the moveable plates 12,14 experience an oscillatory torque applied on them about the “X” axis at a frequency of the driving motion. If the sensing motion's natural resonance frequency is designed to closely match the driving motion's frequency, this oscillatory torque will cause the moveable plates 12, 14 to undergo an oscillatory rotational motion about the “X”0 axis. This results in an oscillatory change in the capacitance of the capacitors 44, 12 and 46, 14. The sensing natural frequency is a function of the rotational inertia of the moveable plates 12, 14 and the restoring force of the single pedestal 20. The sensitivity of the gyroscope is affected by how close the sensing and driving frequency are matched. The smaller the magnitude of mismatch, the higher the output signal level. Note that the whole device is symmetrical about the X-Z plate. The entire structure of this device can be readily fabricated using standard MEMS (Micro-Electro-Mechanical) processes.

In operation, a sinusoidal voltage is applied to both of the stationary plates 36, 38. The frequency of the sinusoidal voltage is set equal to the drive natural frequency of the plates 12, 14. When an angular rate (rotational speed) is applied around any axis in space which is parallel to the X-axis of the gyroscope 10, the two oscillating plates 12, 14 will experience a periodic Coriolis momentum around the X-axis at the sensing frequency. This will cause the both plates 12,14 to resonate around the X-axis at the sensor natural frequency, since the sensing natural frequency is approximately equal to the drive natural frequency. The magnitude of the plates' 12, 14, oscillation is proportional to the input angular rate. Note that there is no phase difference between the two plates 12, 14. As result of the sensing oscillation of the plates 12, 14, the capacitance of the capacitors 44, 12 and 46, 14 will also oscillate at the sensing natural frequency and have a phase difference of 180 degrees. The amplitude of the oscillation of the capacitors is proportional to the input angular rate. Note that the sensing mode is rotational and the drive mode is linear.

Since the drive motion is linear and the sensing motion is rotational, this gyroscope is very insensitive to quadrature error. This is because the capacitance of the non-parallel plate capacitors 44, 12 and 46, 14 is an order of magnitude more sensitive to the angular deflection of the moveable plates 12, 14 around the X-axis than it is to the linear motion along the Y-axis. This gyroscope 10 is very insensitive to any linear acceleration in the Z-axis because both capacitors will have a common shift. Since the capacitors are 180 degrees out of phase, the common shift will be rejected by the differential sensor. The gyroscope is easy to make mechanically, since it only requires a single pedestal and two flexures. The impact of packaging stress is minimized since the moveable structure is only connect to the substrate via one anchor point, i.e., the pedestal.

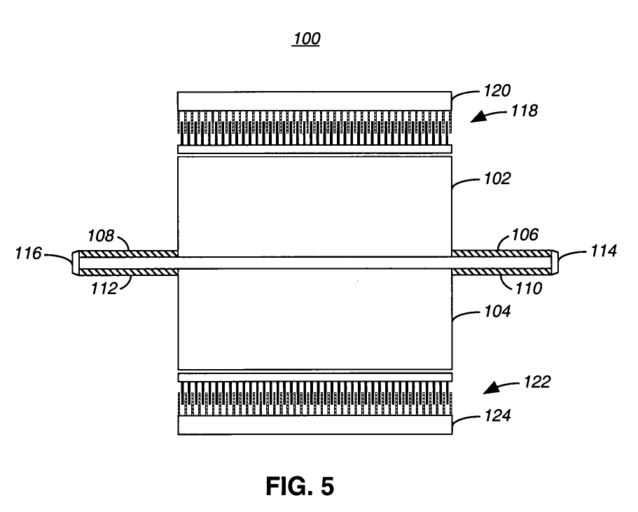

FIG. 5 is a top view of an oscillatory gyroscope 100 in accordance with one embodiment of the invention. This oscillatory gyroscope 100 is very similar to the gyroscope shown in FIGS. 1-4. The oscillatory gyroscope 100 has two planar proof masses 102, 104. The first planar proof mass 102 is supported by a first flexure 106 and a second flexure 108. The second planar proof mass 104 is supported by first flexure 110 and a second flexure 112. The flexures 102, 104, 106 and 108 have a unique design, which is composed by two closely separated straight beams. This Dual Beam Spring (DBS) matches the design of this gyroscope. One challenge for coupled designs is the effort necessary to find a mechanical flexure design which meets both the spring constant along the Y axis and around the “X” axis. This effort is complicated by the fact that any change of the spring dimensions, either in X, Y or Z will cause both spring constants to change. This results in a change for both the sensing and the driving motion frequencies. However, in a DBS (Dual Beam Design) spring design the rotational spring constant of DBS around “X” axis can be adjusted without changing its linear spring constant. This is done by only adjusting the spacing between the two closely packed beams 108, 112 and 106, 110. When the space between the two beams gets larger, the rotational spring constants grows larger, and vice versa. However, in this process the Y axis spring constant remains the same. Therefore, it becomes easy to find a DBS design which matches the sensing motion frequency with the driving motion frequency by adjusting the spacing in the DBS. The first flexures 106, 110 are attached to a first pedestal 114. The second flexures 108, 112 are attached to a second pedestal 116. Despite having two flexures, this embodiment still has a single mechanical structure that supports both the drive mode and the sensing mode. It also still has a linear drive mode and a rotational sensing mode. A first comb drive 118 has a stationary plate 120 and drives the first planar proof mass 102. A second comb drive 122 has a stationary plate 124 and drives the second planar proof mass 104. This embodiment, also has the drive natural frequency that is approximately equal to the sensing natural frequency.

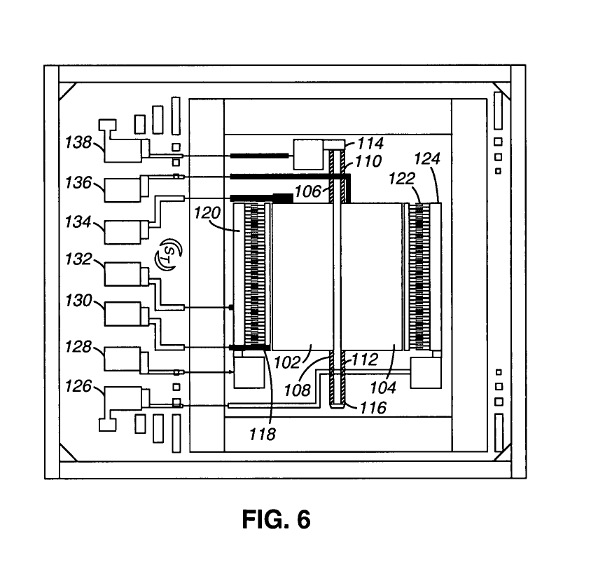

FIG. 6 is a top view of an oscillatory gyroscope 100 with electrical connections in accordance with one embodiment of the invention. The bottom trace 126 connects to the stationary plate 124 and provides the sinusoidal drive voltage. Note that all the mechanical structures are made of a conductive semiconductor, while the substrate is an insulator. The next trace 128 connects to the stationary plate 120. The next trace 130 connects to the first conductive plate 44. The next trace 132 connects to the second conductive plate 46. The next trace 134 connects to the first tuning plate 48. The next 136 trace connects to the second tuning plate 50. The top trace 138 connects to the pedestal 114. The pedestal 114 is electrically connected to the two planar proof masses 102, 104 by the flexures 106, 108, 112 and 110. In one embodiment, the planar proof masses 102, 104 are held at electrical ground.

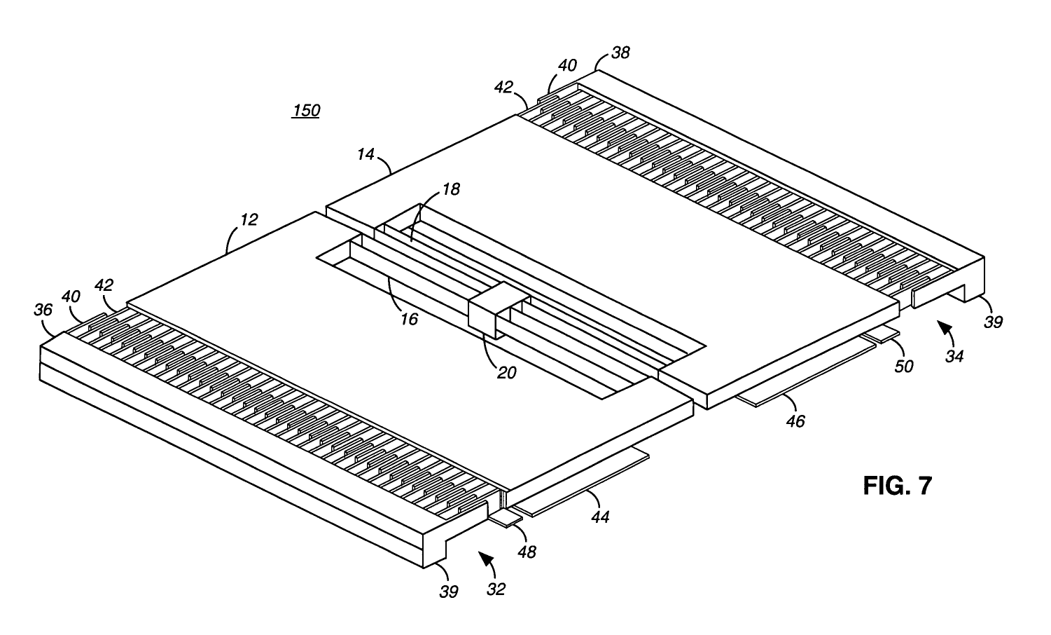

FIG. 7 is a partial perspective view of an oscillatory gyroscope 150 in accordance with one embodiment of the invention. This embodiment, is very similar to the embodiment shown in FIG. 1 and the same reference numerals will be used for similar elements. The only difference between this embodiment and the one in FIG. 1 is that the flexures 16, 18 are the aforementioned DBS design instead of having multiple segments. The simplicity of this design reduces the design cycle time. The design still has all the other feature mention with respect to the embodiment of FIG. 1 including a linear drive motion and a rotational sensing motion.

Thus there has been described an oscillatory gyroscope that is simple mechanically, has a low quadrature error and is less sensitive to linear acceleration.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

1. An oscillatory gyroscope, comprising:
a pair of oscillatory plates, oscillating in a plane;
a single pedestal coupled to the pair of oscillatory plates; and
a pair of sensing capacitors not in the plane.

2. The gyroscope of claim 1, further including a pair of opposing flexures coupled to the pedestal and to the pair of oscillatory plates.

3. The gyroscope of claim 1, wherein a driving mode of the pair of oscillatory plates is linear and a sensing mode of the pair of oscillatory plates is rotational.

4. The gyroscope of claim 3, wherein a drive natural frequency is approximately equal to a sense natural frequency of the pair of oscillatory plates.

5. The gyroscope of claim 1, further including a first comb drive actuator coupled to one of the pair of oscillatory plates and a second comb drive actuator coupled to the other of the pair of oscillatory plates.

6. The gyroscope of claim 5, wherein the first comb drive includes a stationary plate and a movable plate.

7. The gyroscope of claim 6, wherein a drive voltage is applied to the first comb drive.

8. An oscillatory gyroscope, comprising:
a pedestal having a first end attached to a substrate;
a first planar proof mass attached to a second end of the pedestal; and
a second planar proof mass in a same plane as the first planar proof mass attached to the second end of the pedestal.

9. The gyroscope of claim 8, further including a first conductive plate spaced from the first planar proof mass and not in the same plane as the first planar proof mass.

10. The gyroscope of claim 9, further including a second conductive plate spaced from the second planar proof mass and not in the same plane as the second planar proof mass.

11. The gyroscope of claim 10, further including a differential sensor electrically coupled to the first conductive plate and the second conductive plate.

12. The gyroscope of claim 8, further including a first drive actuator acting on the first planar proof mass.

13. The gyroscope of claim 8, wherein the first planar proof mass and the second planar proof mass oscillate in the same plane in a drive mode.

14. The gyroscope of claim 8, wherein a drive natural frequency is approximately equal to a sense natural frequency of the first planar proof mass and the second planar proof mass.

15. An oscillatory gyroscope, comprising:
a pair of oscillatory proof masses having a linear drive mode and a rotational sense mode; and
a pair of electrical sense plates separated from the pair of oscillatory proof masses.

16. The gyroscope of claim 15, wherein a drive natural frequency is approximately equal to a sense natural frequency of the pair of oscillatory proof masses.

17. The gyroscope of claim 16, further including a single mechanical structure that supports both the drive mode and the sensing mode holding the pair of oscillatory proof masses to a substrate.

18. The gyroscope of claim 17, wherein the single mechanical structure includes a pair of flexures coupling the single pedestal to the pair of oscillatory proof masses.

19. The gyroscope of claim 18, further including a pair of drive actuators driving the pair of oscillatory proof masses.

20. The gyroscope of claim 15, further including a differential sensor electrically coupled to the pair of electrical sense plates.
